(19) United States
(12) Patent Application Publication
(10) Pub. No.: US 2008/0276530 A1
(43) Pub. Date: Nov. 13, 2008

(54) Multi-pot container

(75) Inventor: Grzegorz Trabka, Lisle, IL (US)

Correspondence Address: ALAN J. HOWARTH, P.O. BOX 1909, SANDY, UT, 84091-1909, US

(73) Assignee: Grzegorz Trabka to Ball Horticultural Company

(21) Appl. No.: 11/801,962

(22) Filed: May 10, 2007

(51) Int. Cl. A01G 9/02

(52) U.S. Cl. 47/86; 47/65.5

(57) ABSTRACT

A container for plants. The container may include a wall defining a perimeter of the container and a floor at a lower portion of the container. Receptacles may be formed in the container extending beneath the floor for receiving pots, plants, or potting soil. Openings may be formed in the container to allow the container to drain, and for allowing roots to grow through the container. The container may be used as a tray for carrying pots or plants. Also, plants may be placed in the container with or without pots and the container may be placed in a larger patio-type pot or directly in the ground. A mixture of plants may be arranged in the container by moving the smaller pots without damaging the plant roots. Also, the container itself may be planted in the ground without the need to disturb the plant roots.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Invention

The present disclosure relates generally to containers, and more particularly, but not necessarily entirely, to containers having multiple uses, potentially associated with potted plants.

2. Description of Related Art

It is common practice to provide containers for growing, transporting, and/or displaying plants. For example, it is often desirable to grow plants in a controlled environment such as a greenhouse or in a warm climate, and to transport the plants to another location for sale or for planting the plants in the ground, or planting the plants in larger containers or pots. Such containers or pots are commonly used for growing plants indoors or on patios, for example.

Mixed plant containers having a variety of different plants are sometimes produced through multiple steps of growing the plants in initial containers, removing the plants from the initial containers, and arranging them in larger containers. Transplanting the plants from one container to another or into the ground requires significant time and labor and may therefore increase, the cost of the plants. Also, transplanting plants may disturb roots of the plants thereby hindering the performance of the plants. Accordingly, allowing plants to remain in a container without transplanting the plants may serve to reduce costs associated with the plants and also improve the quality and appearance of the plants.

Prior art containers for mixed plant arrangements may also involve growing a variety of plants in a larger container. Accordingly, once the plants are planted in the container, the arrangement may be relatively fixed such that the position of the plants with respect to each other may not be modified without disturbing or otherwise stressing the plants.

Other exemplary embodiments of containers useful for mixed plant arrangements are disclosed in U.S. Pat. No. 6,901,700 to Trabka.

Containers in the form of trays or flats are also commonly used in the prior art to grow or carry plants. The trays are often discarded after use, or sometimes the trays may be recycled for reuse. However such trays are commonly sized and configured in a manner that prevents use of the trays for anything other than merely growing plants or carrying plants or other containers. For example, the trays are commonly formed in a relatively large square or rectangular configuration that is not compatible to be received in other pots. Moreover, trays often have a plain appearance such that the trays are not suitable for providing an attractive display with the plants.

Despite the advantages of known containers for plants, improvements are still being sought. The prior art is characterized by several disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of one embodiment of a container made in accordance with the principles of the present disclosure;

FIG. 2 is a top view of the container of FIG. 1;

FIG. 3 is a side view of the container of FIG. 1;

FIG. 4 is a cross-sectional view of the container of FIG. 1 taken along line A-A of FIG. 2;

FIG. 5 is a break-away side view of two containers stacked together;

FIG. 6 is an exploded side view of the container of FIG. 1 with a plurality of smaller pots for plants receivable in the container, and the container being receivable in a larger pot;

FIG. 7 is a top view of another embodiment of a container made in accordance with the principles of the present disclosure; and

FIG. 8 is a side view of the container of FIG. 7.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present container device and methods for using the container are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

The publications and other reference materials referred to herein to describe the background of the disclosure, and to provide additional detail regarding its practice, are hereby incorporated by reference herein in their entireties, with the following exception: In the event that any portion of said reference materials is inconsistent with this application, this application supercedes said reference materials. The reference materials discussed herein are provided solely for their disclosure prior to the filing date of the present application. Nothing herein is to be construed as a suggestion or admission that the inventors are not entitled to antedate such disclosure by virtue of prior disclosure, or to distinguish the present disclosure from the subject matter disclosed in the reference materials.

It must be noted that, as used in this specification and the appended claims, the singular forms “a,” “an,” and “the” include plural referents unless the context clearly dictates otherwise. Moreover, as used herein, the terms “comprising,” “including,” “containing,” “characterized by,” and grammatical equivalents thereof are inclusive or open-ended terms that do not exclude additional, unrecited elements or method steps.

The term “plant” as used herein shall be construed broadly to include any variety of vegetation, including living, preserved, and artificial vegetation.

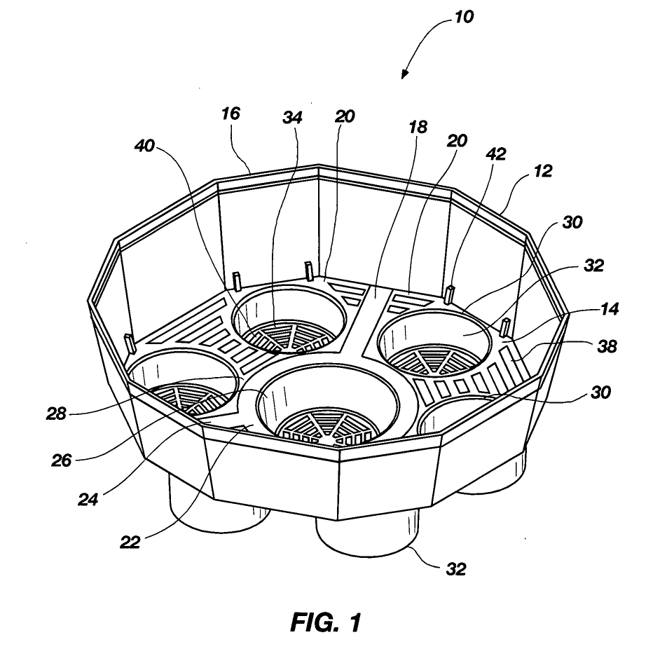

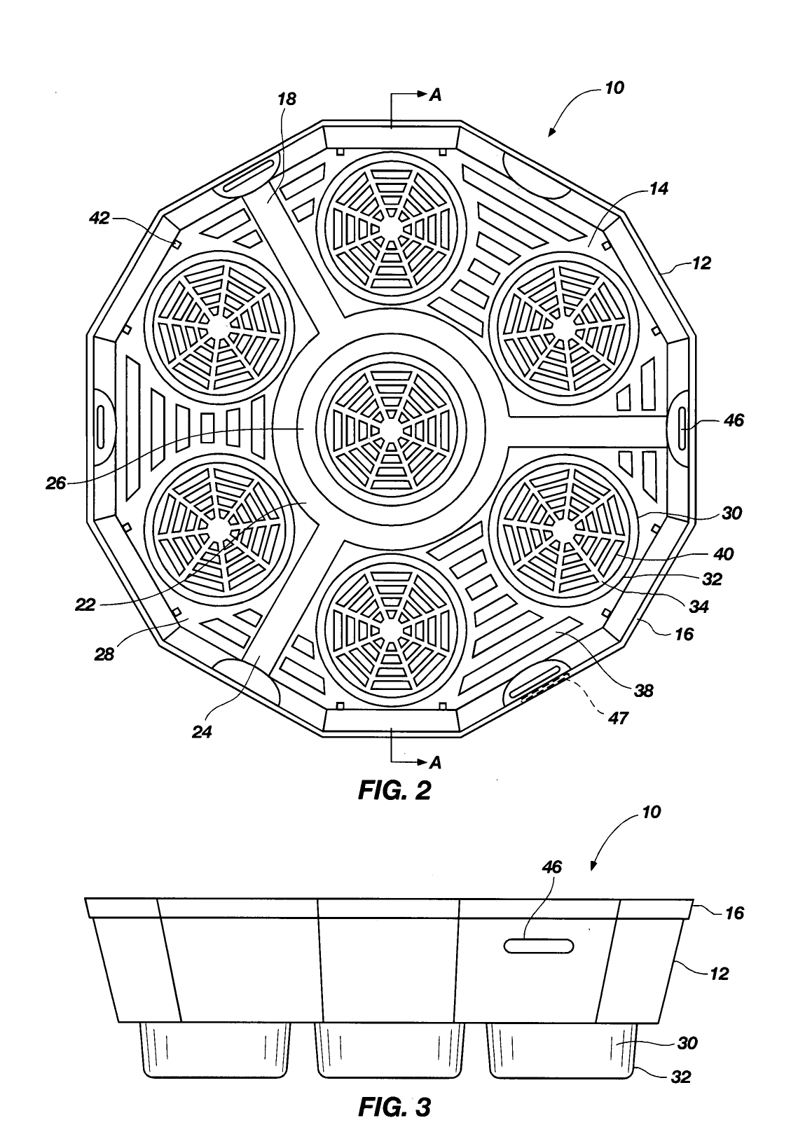

Referring now to FIG. 1, a perspective view is shown of one embodiment of a container, indicated generally at 10, in accordance with the principles of the present disclosure. A top view of the container 10 is shown in FIG. 2, and a side view of the container 10 is shown in FIG. 3. It will be understood that the container 10 may be particularly well suited for receiving objects such as one or more pots, plants, or soil for growing plants. However, it will be understood that the container 10 may be used for receiving various other objects, or for other purposes within the scope of the present disclosure.

The container 10 may include a wall 12 for defining a space for receiving a first portion of the objects such as pots, plants, or soil, for example. It will be understood that the wall 12 may be sized such that a portion of the pots or plants may extend above the wall 12, or the wall 12 may be sized such that the wall 12 is configured to extend above the pots or plants. It will also be understood that a portion of the pots or plants may extend below the wall 12. Moreover, in some instances, the space defined by the wall 12 may not include any portion of a pot or plant, such that an object in the container 10 may be received substantially entirely beneath the wall 12.

A floor 14 may be formed at a lower portion of the wall 12. One embodiment of the wall 12 may slope inwardly from top to bottom such that the container 10 may have a tapered configuration. Alternatively, the wall 12 may extend perpendicularly from the floor 14, or the wall 12 may slope in the opposite direction. It will also be understood that alternative embodiments of the wall 12 may be curved or the wall may have a stepped or irregular configuration.

The container 10 may include a rim 16 disposed on an upper portion of the wall 12. The rim 16 may be formed partially as a corner, bend, or other deformation in the wall 12, such that the rim 16 may be formed integrally with the wall 12. Alternatively, the rim 16 may be formed by joining one or more additional members to the wall 12. The rim 16 may be configured to provide added strength and support to the wall 12. Also, the rim 16 may provide an area for defining slots for receiving tags, handles or the like, as discussed more fully below. Moreover, the rim 16 may be configured to provide an aesthetically pleasing appearance to the container 10. It will be understood that alternative embodiments of the container 10 may be formed without the rim 16.

The container 10 may also include a support 18 located inside the wall 12 for adding strength to the container 10 and for dividing the container 10 into a plurality of regions 20. One embodiment of the support 18 may be formed as a portion of the container 10 having an absence of openings so as to provide strength to the container 10. One embodiment of the support 18 may be configured with a loop 22 and a plurality of spokes 24. The loop 22 may form a first region 26 that may be concentric with the wall 12, and the spokes 24 may extend from the loop 22 to the wall 12. Accordingly, the support 18 may also be configured to form a plurality of exterior regions 28 surrounding the concentric region 26. However, it will be understood that the support 18 may be formed in various different configurations providing a variety of different regions within the scope of the present disclosure. Moreover, some embodiments of the container 10 may be formed without the support 18.

One embodiment of the support 18 may be integrally formed with the wall 12 and the floor 14, whereas other embodiments of the support 18 may be joined to the wall 12 and/or the floor 14 or removably attachable to the wall 12 and/or the floor 14. The support 18 may be formed of a single piece member, or alternatively, the support 18 may be formed of multiple separate members that may or may not be joined together. The support 18 may be substantially flush with the floor 14, or the support 18 may be recessed with respect to the floor 14, or the support 18 may extend in an upward direction from the floor 14 and may extend various different proportions of the height of the wall 12 within the scope of the present disclosure. It will also be understood that some embodiments of the support 18 may be formed as a hollow member, whereas other embodiments of the support 18 may be formed as a solid member without internal cavities within the support 18.

The container 10 may also include a plurality of receptacles 30 for receiving a second portion of the objects in the container 10, such as a portion of the pot, plant, or soil that is not received within the space defined by the wall 12. It will be understood that some embodiments of the container 10 may receive the objects entirely within the space defined by the wall 12, whereas other embodiments of the container 10 may receive the objects entirely within the receptacles 30. However, it will be understood that the container 10 may be configured such that a first portion of the objects, such as an upper portion, may be received in the space defined by the wall 12, and a second portion of the objects, such as a lower portion, may be received in the receptacles 30.

The receptacles 30 may include receptacle walls 32 that may enclose the receptacles in a lateral direction. The receptacle walls 32 may join with the floor 14 such that the receptacles 30 may extend beneath the floor 14. The receptacles 30 may also comprise a receptacle floor 34 that may form a lowermost extent of the receptacles 30 and the container 10.

One embodiment of the container 10 may be formed such that the receptacle walls 32 form a closed boundary, and the container wall 12 defines an exterior perimeter that may circumscribe each of the receptacle walls 32. Also, one embodiment of the container 10 may be configured such that the sum of the area of the receptacles 30 at the floor 12 may be within a range of 25% to 75% of the area of the floor 12. Moreover, one embodiment of the container 10 may be configured such that the height of the receptacles 30 may be within a range of 0% to 50% of the height of the container 10. Another embodiment of the container 10 may be configured such that the height of the receptacles 30 may be within a range of 5% to 35% of the height of the container 10.

It will be understood that the receptacles 30 may be formed in various different sizes, shapes, and configurations. One embodiment of the receptacles 30 may be formed as indentations in the floor 14 with only a minor height as compared to the height of the wall 12. Alternatively, some embodiments of the container 10 may include receptacles 30 that may extend a significant proportion of the height of the container 10.

The receptacles 30 may be arranged in any desired configuration within the scope of the present disclosure. For example, one embodiment of the receptacles 30 may be symmetrically arranged in the container 10 so as to be evenly dispersed throughout the floor 14 of the container 10. One embodiment of the container 10 may include a receptacle 30 that may be positioned in the center of the container 10 concentric with the exterior perimeter of the container 10 formed by the wall 12. One or more additional receptacles 30 may be positioned between the center receptacle 30 and the wall 12. In the embodiment of the container 10 shown in FIGS. 1-5, six additional receptacles 30 may be positioned around the center receptacle 30 for a total of seven receptacles 30. However, it will be understood that other embodiments of the container 10 may have different quantities and arrangements of receptacles 30 within the scope of the present disclosure. Also, the receptacles 30 may be spaced apart such that when pots or plants are placed in the receptacles, sufficient space exists for the pots or plants in the container 10 without interfering with adjacent pots or plants.

One embodiment of the container 10 may include openings 38 for allowing fluid and roots to pass through the container 10. Accordingly, plants, soil, or pots within the container 10 may be allowed to drain moisture from within the container 10, and roots may be allowed to grow through the container 10. Similarly, the receptacle floor 34 may also include receptacle floor openings 40. It will be understood that alternative embodiments of the container 10 may include openings in the receptacle walls 32, or some embodiments may not include openings in one or more of the walls 12, the floor 14, or the receptacle floor 34. Accordingly, various different configurations of openings are contemplated within the scope of the present disclosure. Moreover, the openings 38, 40 may be sized, configured and arranged in any suitable manner within the scope of the present disclosure.

It will also be understood that alternative embodiments of the container 10 may be formed as bottomless containers. For example, one embodiment of the container 10 may be formed without a floor 14, supports 18 or receptacles 30. Other embodiments of the container 10 may be formed without either a floor 14 or receptacle floors 34, or without floors 14 and receptacle floors 34. Accordingly, it will be understood that the container 10 may be formed in various different configurations to allow fluids and roots to pass through the container 10.

It will be understood that the container 10 may be formed of any suitable material known to those skilled in the art. For example, one embodiment of the container 10 may be formed of biodegradable or biofragmentable materials such that the container 10 may be placed in the ground with plants growing therein to avoid having to disturb the roots by removing the plants from the container 10. Other embodiments of the container 10 may be formed of other materials such as plastic, high density polyethylene (HDPE), bio-resin, cardboard, ceramic, metal, wood, or any other suitable material known to those skilled in the art.

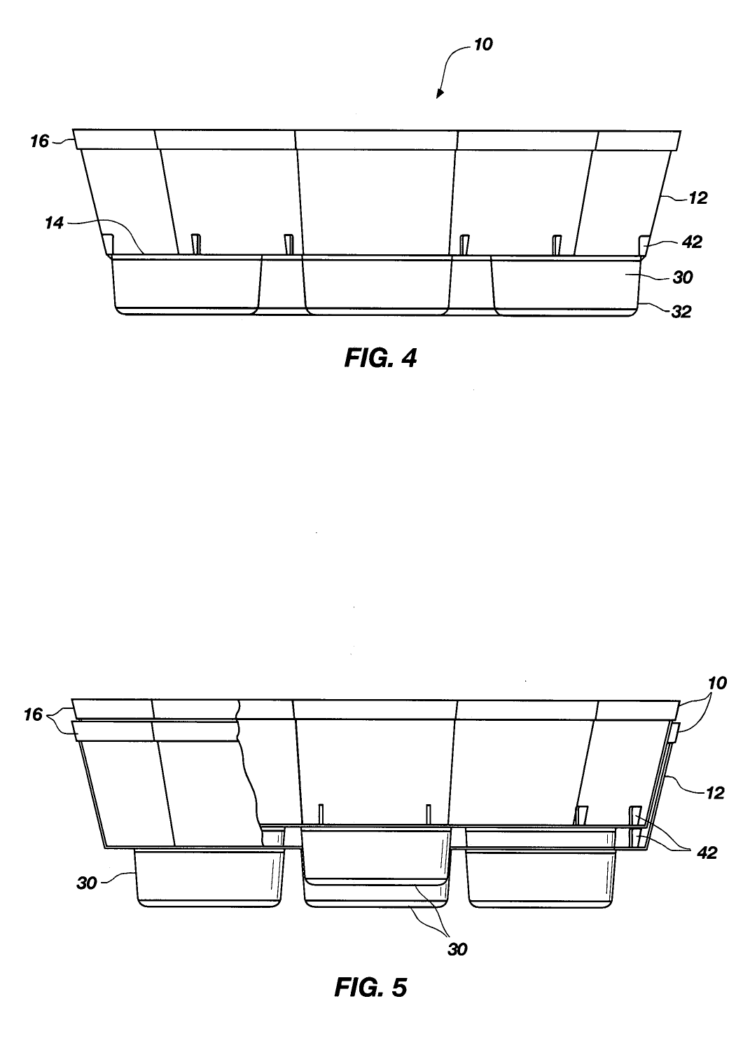

As shown in FIGS. 1 and 2, and as shown in FIG. 4, which shows a cross-sectional view of the container 10 taken along line A-A in FIG. 2, one embodiment of the container 10 may include a plurality of stacking lugs 42. The stacking lugs 42 may be positioned in a corner on an interior side of the wall 12 on an upper side of the floor 14. The stacking lugs 42 may be formed integrally with the wall 12 and the floor 14, or, alternatively, the stacking lugs 42 may be formed of the same or a different material and joined to the wall 12 and/or the floor 14. The stacking lugs 42 may be configured to abut with the bottom surface of a floor 12 of another container 10 as the containers 10 are stacked together, as shown most clearly in FIG. 5. It will be understood that FIG. 5 depicts two containers 10 stacked together. A portion of the containers 10 has been removed in FIG. 5 to reveal part of the interior of the containers 10, including some of the stacking lugs 42. The stacking lugs 42 may allow the stacked containers 10 to be easily separated without becoming wedged together. Also, the stacking lugs may allow the containers 10 to be stacked together and supported evenly, so that the stack of containers 10 may remain stable. It will be understood that any number of containers 10 may be stacked together to occupy less space to facilitate storage, handling or transportation of the containers 10.

One embodiment of the container 10 may include the stacking lugs 42 symmetrically distributed around the perimeter of the floor 14. Any number of stacking lugs 42 may be used within the scope of the present disclosure. For example, one embodiment of the present disclosure may include twelve stacking lugs 42. However, it will be understood that other embodiments of the container 10 may include different quantities of stacking lugs 42, and some embodiments of the container 10 may be formed without any stacking lugs 42.

As shown most clearly in FIG. 2, the container 10 may include one or more slots 46 for attaching a handle or tag. The handle (not shown) may be formed as a flexible member forming a loop with ends of the handle attachable to one or more of the slots 46. Alternatively, the handle may be substantially rigid and configured to be introduced or snapped into one or more of the slots 46. It will also be understood that flexible tags or tags on flexible members may be attached to the container 10 through the slots 46. One embodiment of the container 10 may include two opposing pair of slots 46 formed in an upper portion of the wall 12. Alternatively, the slots may be formed in the rim 16, as indicated by dashed lines at reference numeral 47 in FIG. 2. Other embodiments of the container 10 may have slots 46 of different quantities, sizes, shapes, configurations and locations, and some embodiments of the container 10 may be formed without the slots 46.

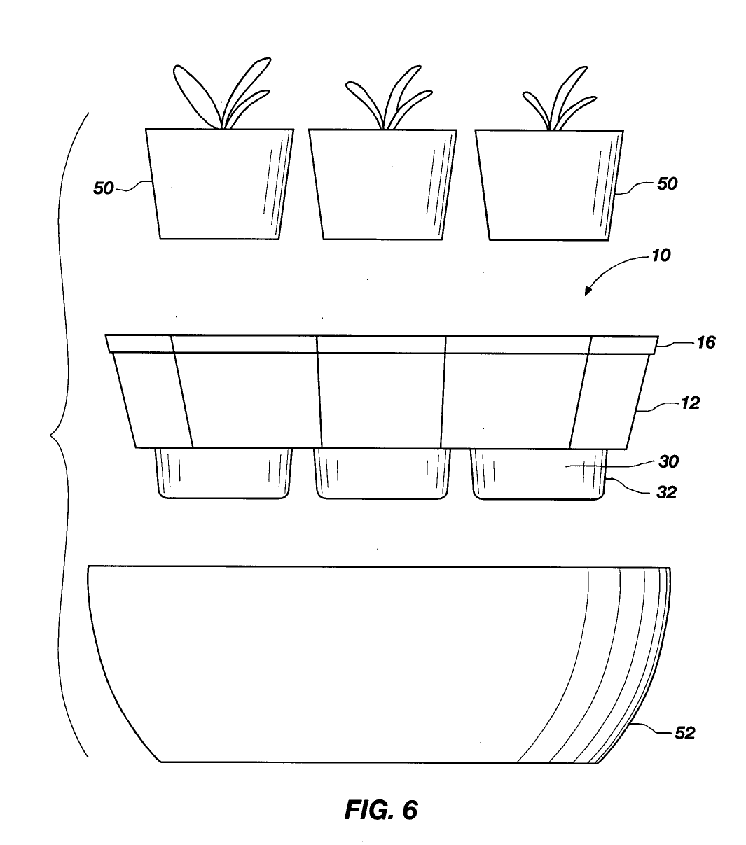

It will be understood that the container 10 may have various different uses within the principles of the present disclosure. For example, as shown in FIG. 6, a plurality of smaller pots 50 may be placed in the receptacles 30 such that the container may be used as a tray for carrying the pots 50. The pots 50 may include potting soil with plants growing therein. Accordingly, the root or lower portion of the plants may be received within the receptacles 30, a portion of the plants may be received within the space defined by the wall 12 of the container 10, and a portion of the plants may extend above the container 10. Alternatively, it will be understood that the wall 12 may be sized such that the pots 50 extend above the wall 12. Use of the container 10 as a tray may be particularly beneficial in situations or establishments where potted plants are sold or distributed.

It will also be understood that the container 10 may alternatively be received within a larger container or pot 52, such as a patio-type pot. Accordingly, the smaller pots 50 may be arranged in the container 10 in a desired configuration, and then the container 10 may be placed within the pot 52. It will be understood that the arrangement of the smaller pots 50 may be altered within the container 10 or the larger pot 52 without disturbing the roots of the plants. Accordingly, various different arrangements of the plants may be accomplished with little labor and disturbance of the plants.

Different plants may be mixed and arranged in the container 10. The smaller pots 50 can be added to the container 10 at the beginning of the plant growth cycle or when the plants are at a marketable size. The smaller pots 50 can be exchanged during the growing season to refresh the design. In one implementation, the plants may be prearranged in a particular design for sale to customers. The customers may remove the smaller pots 50 and place them into a larger pot 52 following the prearranged design. The container 10 may then be recycled or discarded.

Alternatively, potting soil may be placed in the receptacles 30, and plants may be planted directly into the receptacles 30 without intervening pots. Similarly potting soil may be placed within the wall 12 such that soil extends above the floor 14. Plants may then be planted in any arrangement within the container 10. The container 10 may then be placed into a larger pot 52. Alternatively, the plants may be removed from the container 10 for transplanting in the customary manner.

One embodiment of the container 10 may be formed of biodegradable and/or biofragmentable materials such that the container 10 may be placed directly into the ground. Accordingly, the disturbance of the plant roots may be minimized. If smaller pots 50 are placed within the container 10, the smaller pots 50 may also be formed of biodegradable and/or biofragmentable materials.

It will be appreciated that a mixture of different types of plants may be planted in the container 10, or alternatively, a plurality of the same variety of plants may be planted in the container 10. Similarly, the container 10 may be used with a combination of smaller pots 50 in one or more of the receptacles 30, and with potting soil in other receptacles 30 and/or within the wall 12. Accordingly, the container may be versatile for various different uses and combinations of pots and soil contained in different parts of the container 10.

It will also be understood that one embodiment of the container 10 may be used as a hanging basket. Accordingly, a hook may be joined to the container 10 for hanging the container 10 on an overhead support.

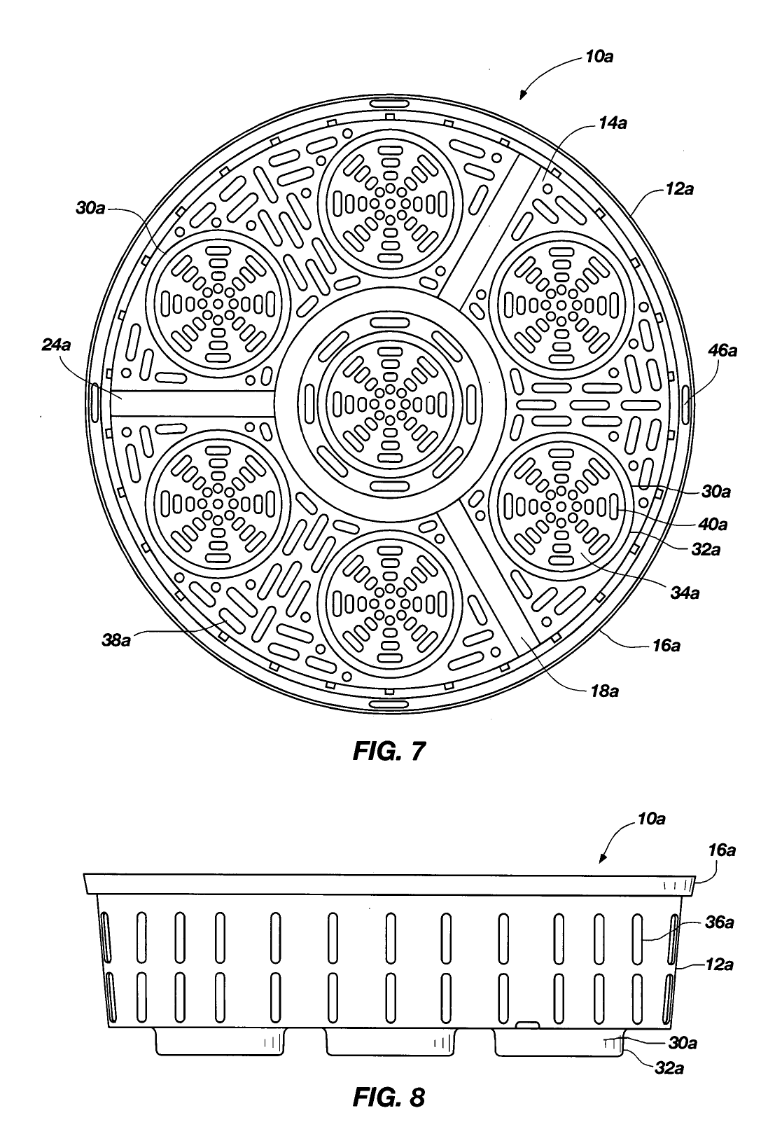

Referring now to FIGS. 7 and 8, an alternative embodiment container is shown, indicated generally at 10a. As previously discussed, the presently preferred embodiments of the disclosure illustrated herein are merely exemplary of the possible embodiments of the disclosure, including that illustrated in FIGS. 7 and 8.

It will be appreciated that the embodiment of the disclosure illustrated in FIGS. 7 and 8 contains many of the same structures represented in FIGS. 1-6. New or different structures will be explained to most succinctly describe the additional advantages that come with the embodiments of the disclosure illustrated in FIGS. 7 and 8.

FIG. 7 depicts a top view of an alternative embodiment container 10a, whereas a side view of the alternative embodiment container 10a is depicted in FIG. 8. The container 10a may include a wall 12a having a round configuration when viewed from above as shown in FIG. 7, as opposed to the polygonal configuration of the container 10 shown in FIG. 2. It will be appreciated that alternative embodiments of the container may have various different shapes within the scope of the present disclosure, such as oval, or irregular shapes, or other polygonal shapes including square and rectangular shapes, for example.

The wall 12a may include openings 36a for allowing moisture to drain from within the container 10a. The container 10a may also include floor openings 38a and receptacle floor openings 40a, similar to the previously disclosed embodiment. However, it will be appreciated that the quantity, size, configuration, location and arrangement of the openings 36a, 38a, 40a, may be different than the previously disclosed embodiment. Moreover, it will be understood that other embodiments may have yet different quantities, sizes, configurations, locations and arrangements of the openings 36a, 38a, 40a, and some embodiments may be formed without any openings.

It will be understood that the container 10, 10a may be formed or manufactured in any suitable manner known to those skilled in the art. For example, one embodiment of the container 10, 10a may be formed using a mold in a manner well known in the manufacturing industry.

It will be appreciated that the structure and apparatus disclosed herein is merely exemplary of a means for defining a space, and a means for receiving a plurality of pots or plants. It should be appreciated that any structure, apparatus or system which performs functions the same as, or equivalent to, those disclosed herein are intended to fall within the scope of a means for defining a space, and/or a means for receiving a plurality of pots or plants, including those structures, apparatuses, or systems that are presently known, or that may become available in the future. Anything that functions the same as, or equivalently to, a means for defining a space, or a means for receiving a plurality of pots or plants, falls within the scope of these elements.

In accordance with the features and combinations described above, a useful method of arranging plants includes the steps of:

(a) providing a container having a floor and a plurality of receptacles extending beneath the floor;

(b) placing either pots or plants within the receptacles; and

(c) placing the container in either a larger container or the ground.

Those having ordinary skill in the relevant art will appreciate the advantages provide by the features of the present disclosure. For example, it is a feature of the present disclosure to provide a container that is simple in design and manufacture. Another feature of the present disclosure is to provide such a container that can be used to receive multiple pots or plants. It is a further feature of the present disclosure, in accordance with one aspect thereof, to provide a container with a plurality of receptacles for receiving smaller pots for use as a tray for carrying plants. An additional feature of the present disclosure is to provide a container that can be filled with potting mix and planted with several plants. It is another feature of the present disclosure to provide a container that can be filled with smaller pots for direct insertion into the ground or a larger container such as a patio-type pot. It is a further feature of the present disclosure to provide a container that can receive smaller pots that can be exchanged and rearranged. It is an additional feature of the present disclosure to provide a container into which a combination of plants may be prearranged, and subsequently rearranged if desired. It is another feature of the present disclosure to provide a container that can be used as a hanging basket. It is an additional feature of the present disclosure to provide a container for use in reducing root disturbance.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly, and use may be made without departing from the principles and concepts set forth herein.

1. A container for objects, said container comprising:
a wall for defining a space for receiving a first portion of said objects, said wall defining an exterior perimeter;
a floor disposed on a lower portion of said wall;
a support integrally formed in said floor, said support comprising a loop that is concentric with said exterior perimeter and a plurality of spokes that extend between said loop and said exterior perimeter; and
a plurality of receptacles defined in said floor, said plurality of receptacles extending beneath said floor such that said container is configured to receive a second portion of said objects in said plurality of receptacles;
wherein one of said plurality of receptacles is disposed within said loop.

2. The container of claim 1, wherein said plurality of receptacles each comprises a receptacle wall forming a closed boundary.

3. The container of claim 2, wherein each of said receptacle walls is circumscribed by said exterior perimeter.

4. The container of claim 3, wherein said support divides said space into a plurality of regions.

5. The container of claim 4, wherein at least one of said plurality of receptacles is positioned in each of said plurality of regions.

6. The container of claim 4, wherein said plurality of regions comprises a first region that is concentric with said exterior perimeter.

7. The container of claim 6, wherein said one of said plurality of receptacles that is disposed in said loop is concentric with said exterior perimeter.

8. The container of claim 1, wherein said wall comprises a plurality of openings for allowing fluid and roots to pass through said wall.

9. The container of claim 1, wherein said floor comprises a plurality of openings for allowing fluid and roots to pass through said floor.

10. The container of claim 1, wherein each of said plurality of receptacles comprises a receptacle floor, and wherein said receptacle floor comprises a plurality of openings for allowing fluid and roots to pass through said receptacle floor.

11. The container of claim 1, wherein said container comprises a rim on an upper portion of said wall.

12. The container of claim 1, further comprising a plurality of stacking lugs for supporting a second container when said second container is stacked on said container.

13. The container of claim 12, wherein said plurality of stacking lugs are located in a corner between said floor and said wall.

14. The container of claim 1, wherein said plurality of receptacles each comprise a receptacle wall forming a closed boundary;
wherein each of said receptacle walls is circumscribed by said exterior perimeter;
wherein said support provides strength to said container and divides said space into a plurality of regions;
wherein at least one of said plurality of receptacles is positioned in each of said plurality of regions;
wherein said plurality of regions comprises a first region that is concentric with said exterior perimeter;
wherein one of said plurality of receptacles is concentric with said exterior perimeter;
wherein said floor comprises a plurality of openings for allowing fluid and roots to pass through said floor;
wherein each of said plurality of receptacles comprises a receptacle floor, and wherein said receptacle floor comprises a plurality of openings for allowing fluid and roots to pass through said receptacle floor;
wherein said container comprises a rim on an upper portion of said wall;
wherein said container further comprises a plurality of stacking lugs for supporting a second container when said second container is stacked on said container;
wherein said plurality of stacking lugs are located in a corner between said floor and said wall;
wherein a sum of an area of the receptacles at the floor is within a range of 25% to 75% of an area of the floor; and
wherein a height of the receptacles is within a range of 0% to 50% of a height of the container.

15. A container for objects, said container comprising:
a wall for defining a space for receiving a first portion of said objects, said wall defining an exterior perimeter;
a plurality of receptacles fixed with respect to said wall, each of said plurality of receptacles comprising a receptacle wall forming a closed boundary for receiving a second portion of said objects;
wherein each of said receptacle walls is circumscribed by said exterior perimeter.

16. The container of claim 15, further comprising a floor disposed on a lower portion of said wall.

17. The container of claim 16, wherein said plurality of receptacles extend beneath said floor.

18. The container of claim 15, further comprising a support positioned within said exterior perimeter for providing strength to said container and dividing said space into a plurality of regions.

19. The container of claim 16, wherein each of said plurality of receptacles comprises a receptacle floor, and wherein at least one of said receptacle floor, said wall and said floor comprises a plurality of openings for allowing fluid and roots to pass through said container.

20. The container of claim 15, further comprising a plurality of stacking lugs disposed on said wall for supporting a second container when said second container is stacked on said container.

21. A container for one or more objects, said container comprising:
means for defining a space for receiving a first portion of said one or more objects; and
means positioned beneath said space for receiving a second portion of said one or more objects.

22. The container of claim 21, further comprising a floor disposed at a bottom of said space.

23. The container of claim 21, wherein said means for defining a space comprises a wall.

24. The container of claim 21, wherein said means positioned beneath said space for receiving a second portion of said objects comprises a plurality of receptacles.

25. The container of claim 21, further comprising a plurality of stacking lugs for supporting a second container when said second container is stacked on said container.

26. A container for objects, said container comprising:
a wall for defining a space for receiving a first portion of said objects, said wall defining an exterior perimeter;
a plurality of receptacles each configured for receiving a second portion of said objects therein, wherein said plurality of receptacles comprises a first receptacle that is concentric with said exterior perimeter, and at least one second receptacle disposed between said first receptacle and said exterior perimeter.

27. The container of claim 26, further comprising a floor disposed on a lower portion of said wall.

28. The container of claim 27, wherein said plurality of receptacles extends beneath said floor.

29. The container of claim 26, wherein said plurality of receptacles comprises seven receptacles.

30. The container of claim 26, further comprising a plurality of openings for allowing said container to drain.

31. The container of claim 26, further comprising a plurality of stacking lugs disposed on said wall for supporting a second container when said second container is stacked on said container.

32. A container for objects, said container comprising:
a wall for defining a space for receiving a first portion of said objects, said wall defining an exterior perimeter;
a support positioned within said exterior perimeter for providing strength to said container and dividing said space into a plurality of regions; and
at least one receptacle in each of said plurality of regions, said receptacles being configured for receiving a second portion of said objects therein.

33. The container of claim 32, further comprising a floor disposed on a lower portion of said wall.

34. The container of claim 33, wherein said plurality of receptacles extend beneath said floor.

35. The container of claim 32, wherein at least one of said plurality of receptacles is positioned in each of said plurality of regions.

36. The container of claim 32, wherein said plurality of regions comprises a first region that is concentric with said exterior perimeter.

37. The container of claim 32, wherein one of said plurality of receptacles is concentric with said exterior perimeter.

38. The container of claim 32, further comprising a plurality of openings for allowing fluid and roots to pass through said container.

39. The container of claim 32, further comprising a plurality of stacking lugs disposed on said wall for supporting a second container when said second container is stacked on said container.

40. The container of claim 32, wherein said support comprises a loop that is concentric with said exterior perimeter and a plurality of spokes that extend between said loop and said wall.
